(19) United States
(12) Patent Application Publication
(10) Pub. No.: US 2015/0350650 A1
(43) Pub. Date: Dec. 3, 2015

(54) EFFICIENT SAO SIGNALING

(71) Applicant: Apple Inc., Cupertino, CA (US)

(72) Inventors: Jae Hoon Kim, San Jose, CA (US); Chris Y. Chung, Sunnyvale, CA (US); Hsi-Jung Wu, San Jose, CA (US); Dazhong Zhang, Milpitas, CA (US); Yunfei Zheng, Cupertino, CA (US); Xiaosong Zhou, Campbell, CA (US)

(21) Appl. No.: 14/726,365

(22) Filed: May 29, 2015

Related U.S. Application Data
(60) Provisional application No. 62/004,451, filed on May 29, 2014.

(51) Int. Cl. H04N 19/129; H04N 19/186; H04N 19/184; H04N 19/136

(52) U.S. Cl. CPC H04N 19/129; H04N 19/136; H04N 19/186; H04N 19/184

(57) ABSTRACT

Methods and systems provide efficient sample adaptive offset (SAO) signaling by reducing a number of bits consumed for signaling SAO compared with conventional methods. In an embodiment, a single flag is used if a coding unit to a first scanning direction with respect to a given coding unit is off. In an embodiment, further bits may be saved if some neighboring coding units are not present, i.e. the given coding unit is an edge. For example, a flag may be skipped, e.g., not signaled, if the given coding unit does not have a neighbor. In an embodiment, a syntax element, one or more flags may signal whether SAO filtering is performed in a coding unit. Based on the syntax element, a merge flag may be skipped to save bits. In an embodiment, SAO syntax may be signaled at a slice level.

### CROSS-REFERENCE TO RELATED APPLICATIONS

The present application claims priority to U.S. Patent Application Ser. No. 62/004,451, filed May 29, 2014, the disclosure of which is incorporated herein by reference.

### BACKGROUND

The present disclosure relates to a method of reconstructing signal amplitudes for video coding and compression. More specifically, it relates to methods for signaling whether a Sample Adaptive Offset (SAO) process is used in video coding and processing systems such as within the High Efficiency Video Coding (HEVC) standard.

The HEVC standard, currently published as ISO/IEC 23008-2 MPEG-H Part 2 and ITU-T H.265, introduced several new video coding tools designed to improve video coding efficiency over previous video coding standards and technologies such as MPEG-2, MPEG-4 Part 2, MPEG-4 AVC/H.264, VC1, and VP8. One of these tools is the SAO, which is a filtering mechanism that may be performed after deblock filtering. SAO groups reconstructed pixels into categories and reduces distortion by applying an offset to pixel values based on a classification process. Under the HEVC standard, SAO may be applied for some samples and not applied for other samples. Whether SAO is applied for a particular sample may be signaled in a bitstream. SAO parameters used for one coding tree block (LCU) may also be used for a neighboring LCU, if appropriate.

The conventional SAO signaling protocol defined by the HEVC standard does not specify how flags are signaled for an LCU whose SAO is turned off. By perceiving a need in the art for efficiently using flags, i.e., bits, used for signaling SAO, the inventors have developed methods for efficiently signaling SAO.

### BRIEF DESCRIPTION OF THE DRAWINGS

FIG. 1 is a simplified block diagram of a network system according to an embodiment.

FIG. 2 is a functional block diagram of an encoding and decoding system according to an embodiment.

FIG. 3A is a simplified conceptual diagram of a coding tree block and corresponding signaling scheme according to an embodiment.

FIG. 3B is a simplified conceptual diagram of a coding tree block and corresponding signaling scheme according to another embodiment.

FIG. 3C is a simplified conceptual diagram of a coding tree block and corresponding signaling scheme according to another embodiment.

FIG. 3D is a simplified conceptual diagram of a coding tree block and corresponding signaling scheme according to another embodiment.

FIG. 4A is a simplified conceptual diagram of video blocks according to an embodiment.

FIG. 4B illustrates signaling for various configurations of video blocks according to an embodiment.

FIG. 5 is a flowchart illustrating a method of signaling according to an embodiment.

FIG. 6 is a flowchart illustrating a method of signaling according to another embodiment.

FIG. 7A is a simplified conceptual diagram of a coding tree block and corresponding signaling scheme according to an embodiment.

FIG. 7B is a simplified conceptual diagram of a coding tree block and corresponding signaling scheme according to another embodiment.

FIG. 7C is a simplified conceptual diagram of a coding tree block and corresponding signaling scheme according to another embodiment.

FIG. 7D is a simplified conceptual diagram of a coding tree block and corresponding signaling scheme according to another embodiment.

FIG. 7E illustrates signaling for various configurations of video blocks according to an embodiment.

FIG. 8 is a flowchart illustrating a method of signaling according to an embodiment.

FIG. 9 is a flowchart illustrating a method of signaling according to another embodiment.

### DETAILED DESCRIPTION

Methods and systems of the present disclosure provide techniques for signaling a state of sample adaptive offset (SAO) for a given coding unit. In an embodiment, a method may determine whether the SAO state for a given coding unit is different from an SAO state of a first neighbor in a first scanning direction. If the SAO state for the given coding unit is different from the SAO state of the first neighbor, the method may determine whether an SAO state is off for the first neighbor. If the first neighbor's SAO state is off, the method may signal the SAO state for the given coding unit with a single flag.

In another embodiment, a method may signal a state of SAO for coding units of a frame. The method may be performed iteratively for a plurality of coding units within a frame. The method may include determining whether the respective coding unit has a first neighbor in a first scanning direction. When the respective coding unit does not have a first neighbor, the method may code an SAO state of the respective coding unit according to an SAO state of a coding unit in a second scanning direction in relation to the respective coding unit. Otherwise, the method may code the SAO state of the respective coding unit according to an SAO state of the coding unit in a first direction in relation to the respective coding unit. The method may provide that a protocol for representing SAO state of the coding units at an interior of the frame includes a field for a flag representing state of neighbors in the first scanning direction of the interior coding units but the protocol does not include such a flag for coding units at an edge with respect to the first scanning direction of the frame.

According to an embodiment, a method may signal a sample adaptive offset (SAO) state by signaling SAO data for each coding units in a frame according to a variable field signaling protocol. For a coding unit in an interior of the frame (e.g., not on an edge), when SAO signaling is present for a previously-coded coding unit adjacent to a present coding unit and the SAO state of the previously-coded coding unit agrees with the SAO state of the present coding unit, the signaling comprises providing a flag indicating that the SAO state of the present coding unit is the same as the SAO state of the first previously-coded coding unit. For a coding When SAO signaling is present for a previously-coded coding unit adjacent to the present coding unit in an alternate second direction and an SAO state of the previously-coded coding unit agrees with the SAO state of the present coding unit, the signaling comprises providing a pair of flags, where the first flag indicates that the SAO state of the present coding unit does not agree with the SAO state of the first previously-coded coding unit and a second flag indicates that the SAO state of the present coding unit is the same as the SAO state of the second previously-coded coding unit. When the SAO states of both of the adjacent coding units is not the same as the current coding unit, SAO state data is provided in a four field syntax unit including a pair of flags indicating that the SAO state of the present coding unit does not agree with the SAO state of the first previously-coded coding unit and the SAO state of the second previously-coded coding unit, the syntax unit also including a pair of fields with SAO state values. The techniques described herein may provide savings in the number of bits used for signaling an SAO state compared with conventional techniques. For example, the techniques may reduce the number of fields or flags used for signaling an SAO state.

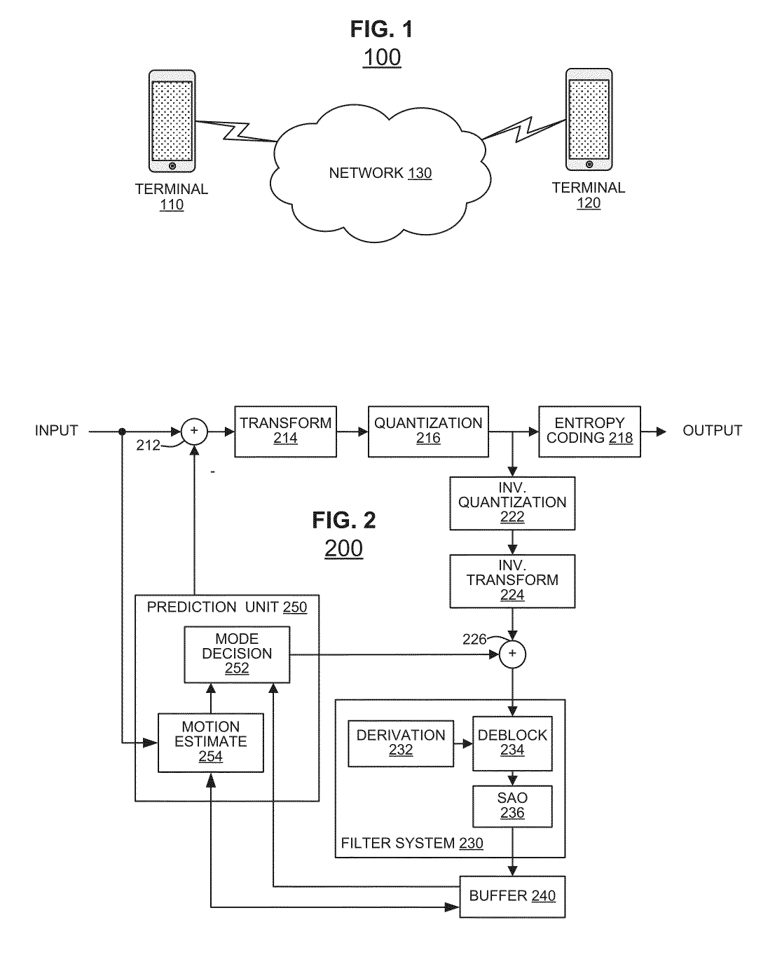

FIG. 1 is a simplified block diagram of a video coding system 100 according to an embodiment. The system 100 may include a plurality of terminals 110, 120 interconnected via a network 130. The terminals 110, 120 each may capture video data at a local location and code the video data for transmission to the other terminal via the network 130. Each terminal 110, 120 may receive the coded video data of the other terminal from the network 130, reconstruct the coded data, and display video data recovered therefrom.

In FIG. 1, the terminals 110, 120 are illustrated as smart phones but the principles of the present disclosure are not so limited. Embodiments of the present disclosure find application with personal computers (both desktop and laptop computers), tablet computers, computer servers, media players, and/or dedicated video conferencing equipment.

The network 130 represents any number of networks that convey coded video data between the terminals 110, 120, including, for example, wireline and/or wireless communication networks. The communication network 130 may exchange data in circuit-switched or packet-switched channels. Representative networks include telecommunications networks, local area networks, wide area networks, and/or the Internet. For the purposes of the present discussion, the architecture and topology of the network 130 are immaterial to the operation of the present disclosure unless explained herein.

FIG. 2 shows a simplified block diagram of a coding system 200 in an embodiment of the disclosure that includes components for encoding and decoding video data. The system 200 may include a subtractor 212, a transform unit 214, a quantizer 216, and an entropy coding unit 218.

The subtractor 212 may receive an input motion compensation block from a source image and, depending on a prediction mode used, a predicted motion compensation block from a prediction unit 250. The subtractor 212 may subtract the predicted block from the input block and generate a block of pixel residuals. If no prediction is performed, the subtractor 212 simply may output the input block without modification. The transform unit 214 may convert the block it receives to an array of transform coefficients according to a spatial transform such as a discrete cosine transform (“DCT”) or a wavelet transform. The quantizer 216 may truncate transform coefficients of each block according to a quantization parameter (“QP”). The QP values used for truncation may be transmitted to a decoder in a channel. The entropy coding unit 218 may code the quantized coefficients according to an entropy coding algorithm, for example, a variable length coding algorithm or context-adaptive binary arithmetic coding. Additional metadata containing the message, flag, and/or other information discussed above may be added to or included in the coded data, which may be output by the system 200.

The system 200 also may include an inverse quantization unit 222, an inverse transform unit 224, an adder 226, a filter system 230, a buffer 240, and a prediction unit 250. The inverse quantization unit 222 may quantize coded video data according to the QP used by the quantizer 216. The inverse transform unit 224 may transform re-quantized coefficients to the pixel domain. The adder 226 may add pixel residuals output from the inverse transform unit 224 with predicted motion data from the prediction unit 250. The summed output from the adder 226 may be output to the filtering system 230.

The filtering system 230 may include a deblocking filter 234, a strength derivation unit 232, and a sample adaptive offset (SAO) filter 236. The filters in the filtering system 230 may be applied to reconstructed samples before they are written into a decoded picture buffer 240 in a decoder loop. The deblocking filter 236 may apply deblock filtering to recover video data output from the adder 226 at a strength provided by the strength derivation unit 232. The strength derivation unit 232 may derive a strength value using any of the techniques described herein.

The SAO filter 236 may be configured to perform at least one of the offset features described herein, and in some instances may perform different combinations of two or more of the offset features described herein. SAO filtering may be applied adaptively to all samples satisfying particular conditions defined herein. SAO may modify decoded samples by conditionally adding an offset value to each sample based on values in look-up tables transmitted by an encoder. For example, a classifier index specifying classification of each sample and offsets of the samples may be encoded by entropy coder 218 in a bitstream. In a decoding processor, the classifier index and offsets may be decoded by a corresponding decoder. The filtering system 230 also may include other types of filters, but these are not illustrated in FIG. 2 merely to simplify presentation of the present embodiments of the disclosure.

The buffer 240 may store recovered frame data as output by the filtering system 230. The recovered frame data may be stored for use as reference frames during coding of later-received blocks.

The prediction unit 250 may include a mode decision unit 252 and a motion estimator 254. The motion estimator 254 may estimate image motion between a source image being coded and reference frame(s) stored in the buffer 240. The mode decision unit 252 may assign a prediction mode to code the input block and select a block from the buffer 240 to serve as a prediction reference for the input block. For example, it may select a prediction mode to be used (for example, uni-predictive P-coding or bi-predictive B-coding), and generate motion vectors for use in such predictive coding. In this regard, prediction unit 250 may retrieve buffered block data of selected reference frames from the buffer 240.

A largest coding unit (“LCU”), also known as a coding tree unit (“CTU”), forms the core of the coding layer in HEVC. The LCU corresponds to the macroblock of other coding protocols. A CTU includes a luma coding tree block (“CTB”) and a chroma CTB. According to subclause 7.4.9.3 of the HEVC standard, sao_type_idx_luma specifies an offset type for the luma component of a CTB, and sao_type_idx_chroma specifies an offset type for the chroma component of the CTB. SAO parameters used for one LCU may also be used for a neighboring LCU, if appropriate. For example, merge_left=1 specifies that some syntax elements, including sao_type_idx_luma and sao_type_idx_chroma, are derived from the corresponding syntax elements of a LCU to the left of the LCU being currently coded. merge_left=0 specifies that those syntax elements are not derived from the left LCU. When merge_left is not present, it is inferred to be equal to 0. Similarly, merge_up=1 specifies that some syntax elements, including sao_type_idx_luma and sao_type_idx_chroma, are derived from the corresponding syntax elements of a LCU above the LCU being currently coded. merge_up=0 specifies that those syntax elements are not derived from the above LCU, and when merge_left is not present, it is inferred to be equal to 0.

The existing SAO signaling protocol defined by the HEVC standard does not specify how the merge flags (merge_left and merge_up) are signaled for an LCU whose SAO is turned off. By perceiving a need in the art for efficiently using the number of flags (i.e., bits) used for signaling SAO, the inventors have developed methods for signaling that SAO is off for a LCU.

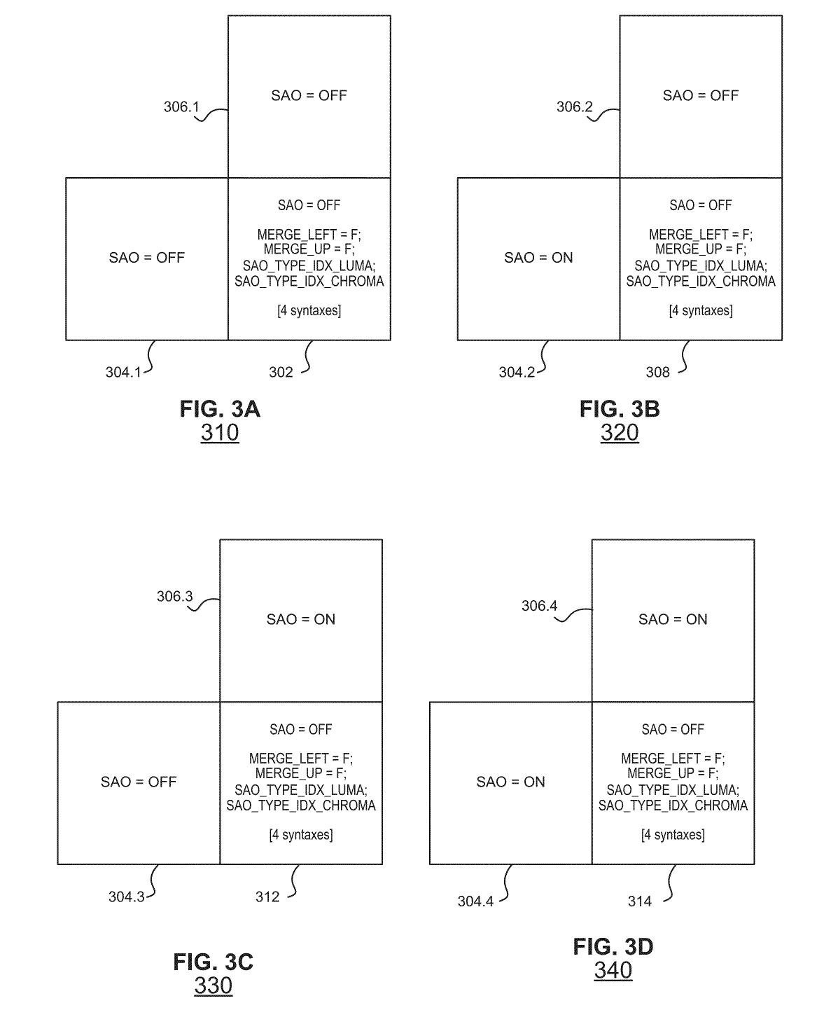

FIGS. 3A-3D illustrate a first method of signaling that SAO is off for a given LCU in various neighboring LCU configurations. For each configuration, three (if either of luma or chroma is signaled) or four (if both luma and chroma are signaled) syntax elements may be used to signal that a current LCU does not use SAO. If SAO is off for a current block, regardless of its neighbor's SAO status, merge_left=FALSE and merge_up=FALSE may be signaled, along with sao_type_idx_luma and sao_type_idx_chroma values. In configuration 310, for a current LCU 302, both a left neighbor 304.1 and an above neighbor 306.1 do not use SAO. In configuration 320, for a current LCU 308, a left neighbor 304.2 uses SAO and an above neighbor 306.2 does not use SAO. In configuration 330, for a current LCU 312, a left neighbor 304.3 does not use SAO and an above neighbor 306.3 uses SAO. In configuration 340, for a current LCU 314, both a left neighbor 304.4 and an above neighbor 306.4 use SAO. Regardless of the values of the neighbors (i.e., whether SAO is on or off for the neighbors), three or four syntax elements may be used: merge_left=FALSE, merge_up=FALSE, sao_type_idx_luma=FALSE, and sao_type_idx_chroma=FALSE.

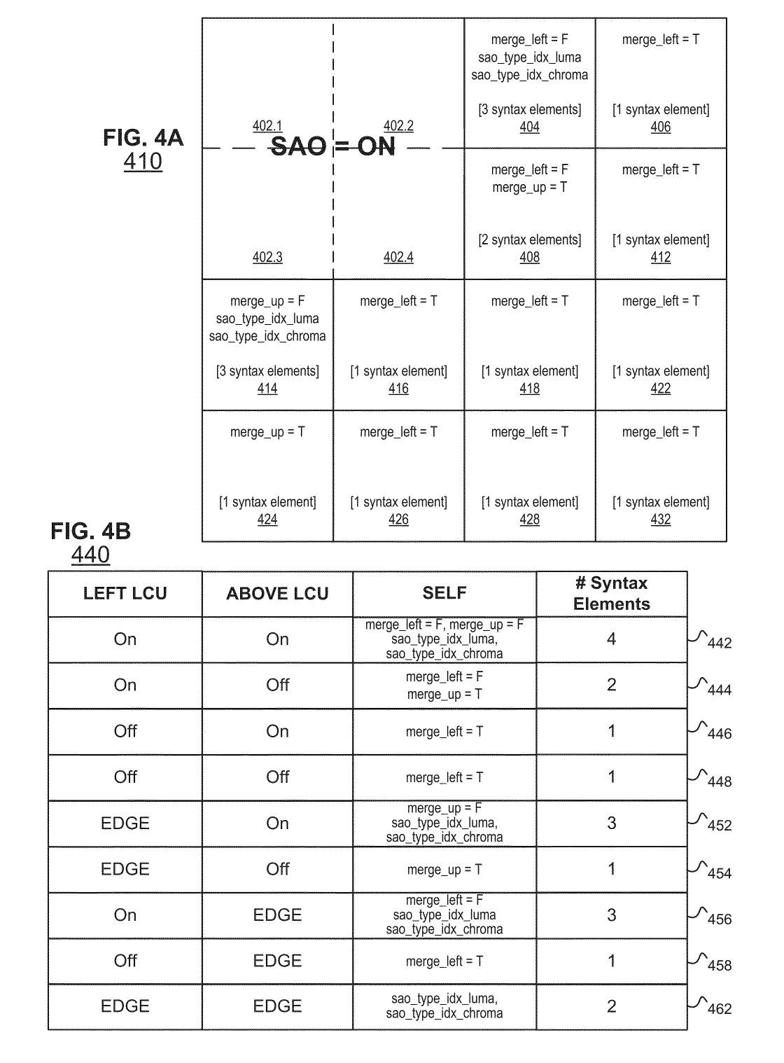

FIG. 4A is a simplified conceptual diagram of a group 410 of neighboring video blocks 402-432. For example, the group may form a frame. Each of the blocks 402-432 may be an LCU. As illustrated, the group 410 is a 4×4 group of LCUs. For some of the LCUs 402.1-402.4, SAO is on. For other LCUs 404-432, SAO is off. According to an embodiment of the present disclosure, fewer flags may be used to signal that SAO is off for blocks 406-412 and 416-432 compared with the existing HEVC signaling protocol.

FIG. 4B is a table 440 summarizing each configuration in the group 410 of neighboring blocks. Each row includes the status (SAO signaling on or off) of the left LCU and the above LCU, the flags that are signaled to indicate that the current LCU is off, and the number of syntax elements (i.e., flags) that may be used for the signaling. The first column includes the status of the left LCU, the second column includes the status of the above LCU, the third column includes the status of the flags for a current LCU, and the right-most column includes the number of syntax elements used for the signaling. For instance, row 444may correspond to LCU 408, in which the left LCU 402.4 is on and the above LCU 404 is off. For the case of LCU 408, two syntax elements, sao_merge_left flag (represented as “merge_left”) and sao_merge_up_flag (represented as “merge_up”) are used for signaling. Because merge_up is TRUE for LCU 408 and LCU 408 takes on the value of its above neighbor 404, additional syntax elements (e.g., sao_type_idx_luma and sao_type_idx_chroma) need not be signaled. As another example, row 446 may correspond to LCU 416, in which the left LCU 414 is off and the above LCU 402.4 is on. For the case of LCU 416, one syntax element, merge_left is used for signaling.

Sometimes an LCU may be located at an edge, i.e., it does not have a left and/or above neighbor. For example, row 456 may correspond to LCU 404 in which the left LCU 402.2 is on and there is no above LCU (indicated by “EDGE” in table 440). For the case of LCU 404, three syntax elements, merge_left, sao_type_idx_luma and sao_type_idx_chroma, may be used for signaling. Because merge_left is FALSE for LCU 404 and there is no data for merge_up, the sao_type_idx_luma and sao_type_idx_chroma flags are also signaled to indicate that SAO for LCU 404 is off. In another example, row 452 corresponds to LCU 414 in which there is no left LCU and above LCU 402.3 is on. For the case of LCU 414, three syntax elements, merge_up, sao_type_idx_luma and sao_type_idx_chroma, may be used for signaling. Because merge_up is FALSE for LCU 414 and there is no data for merge_left, the sao_type_idx_luma and sao_type_idx_chroma flags are also signaled to indicate that SAO for LCU 414 is off. In a further example, row 454 may correspond to LCU 424, in which there is no left LCU and the above LCU 414 is off. For the case of LCU 424, one syntax element, merge_up may be used for signaling.

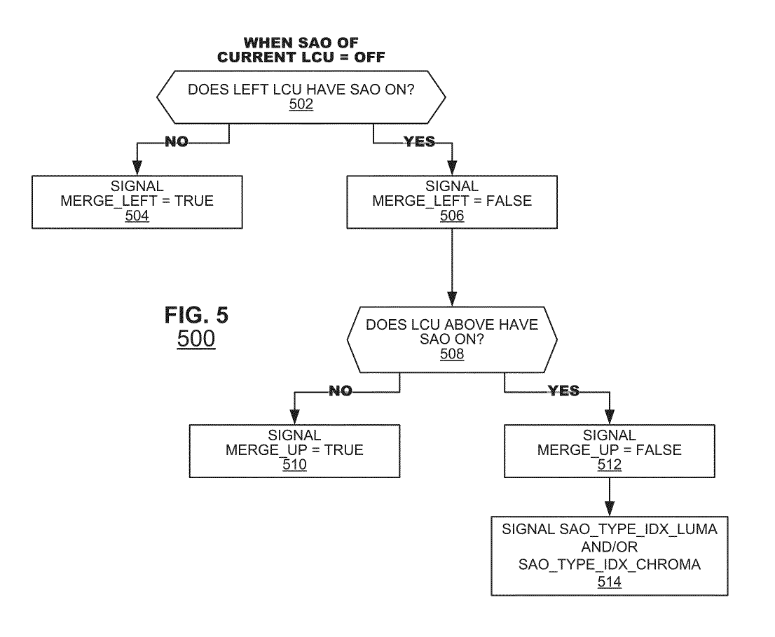

FIG. 5 illustrates a method 500 for signaling SAO status when SAO of a current LCU is set to off according to an embodiment of the present disclosure. In box 502, the method 500 may determine whether a LCU to the left of the LCU has SAO signaling turned on. If SAO for the left LCU is off, the method 500 may signal merge_left is TRUE and terminate (box 504). For example, rows 446, 448, and 458 of table 440 may correspond to box 504. If, on the other hand, the left LCU has SAO on, the method 500 may signal merge_left is FALSE in box 506 then proceed to evaluate whether the LCU above the current LCU has SAO signaling turned on (box 508). If SAO for the above LCU is off, the method 500 may signal merge_up is TRUE and terminate (box 510). For example, row 444 of table 440 may correspond to box 510. If, on the other hand, the method 500 determines that the above LCU has SAO on, the method 500 may signal merge_up is FALSE in box 512 and may also signal sao_type_idx_luma and/or sao_type_idx_chroma in box 514. For example, row 442 of table 440 corresponds to such a result.

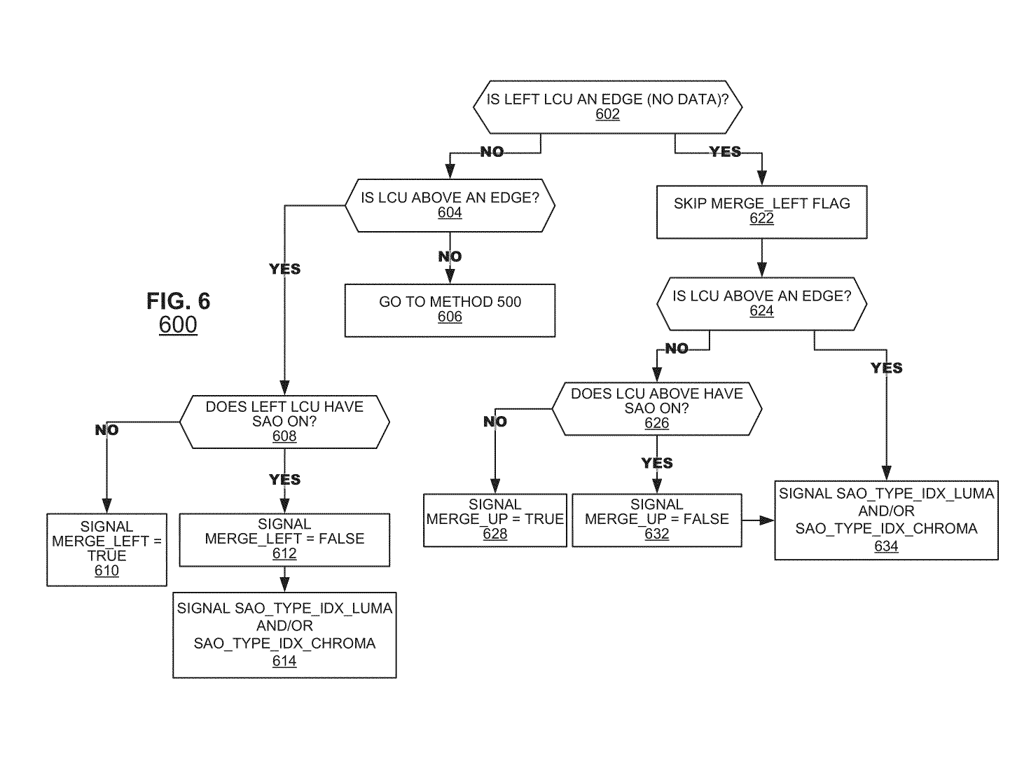

FIG. 6 illustrates a method 600 of signaling SAO status when SAO of a current LCU is set to off according to an embodiment of the present disclosure. In this embodiment, the method 600 may account for LCUs at edges of a frame (i.e., there are no samples to the left or above the current LCU). In box 602, the method 600 may determine whether an LCU to the left of the LCU exists. If there is a left LCU, the method 600 may proceed to box 604 in which it determines whether the LCU above the LCU exists. If there is an above LCU, the method 600 may proceed to method 500 described herein (box 606). If, on the other hand, there is no above LCU, the method 600 may proceed to box 608 in which it determines whether the left LCU has SAO turned on. If SAO is off for the left LCU, then the method 600 may signal merge_left is TRUE (box 610) and terminate. For example, row 458 of table 440 corresponds to such a result. If SAO is on for the left LCU, the method 600 may signal merge_left is FALSE (box 612) and signal the sao_type_idx_luma and/or sao_type_idx_chroma (box 614). For example, row 456 of table 440 corresponds to such a result.

If, in box 602, the method 600 determines that the left LCU does not exist, then the method 600 may skip the merge_left (box 622). This may save signaling resources by saving the bits associated with signaling the merge_left. The method 600 may then proceed to determine whether the above LCU exists (box 624). If the above LCU does not exist, the method 600 may signal sao_type_idx_luma and/or sao_type_idx_chroma in box 634. For example, row 462 of table 440 corresponds to such a result. If, on the other hand, the method 600 determines that the above LCU exists in box 624, then the method 600 may determine in box 626 whether the above LCU has SAO turned on. If LCU is not on for the above LCU, the method 600 may signal merge_up TRUE (box 628) and terminate. For example, row 454 of table 440 corresponds to such a result. Otherwise, if the method 600 determines that SAO for the above LCU is off, the method may signal merge_up is FALSE (box 632) and proceed to box 634 in which it signals sao_type_idx_luma and/or sao_type_idx_chroma. For example, row 452 of table 440 corresponds to such a result.

In another embodiment, SAO syntax may be signaled at the slice level such that one slice is used for the LCUs 402 with SAO on and another slice is used for the LCUs 404-432 with SAO off. For the LCUs having SAO turned off, the slice_sao_luma_flag and the slice_sao_chroma_flag may be set to 0.

According to another method of signaling SAO, additional flags may be used to signal whether SAO is signaled for left and above LCUs. This may further conserve resources by avoiding signaling of the merge_left and merge_up in some situations. In an embodiment, the sample adaptive offset syntax (found in subclause 7.3.8.3 of the HEVC specification) may be modified to include parameters saoInLeft and saoInUp as follows:

Descriptor

sao( rx, ry ){

if( rx > 0 ) {

leftCtbInSliceSeg = CtbAddrInRs > SliceAddrRs
leftCtbInTile =
ileId[ CtbAddrInTs ] = = TileId[ CtbAddrRsToTs[ CtbAddrInRs − 1 ] ]

if( leftCtbInSliceSeg && leftCtbInTile && saoInLeft )

| | |
|---|---|
| merge_left | ae(v) |

}
if( ry > 0 && !merge_left ) {

upCtbInSliceSeg = ( CtbAddrInRs − PicWidthInCtbsY ) >= SliceAddrRs
upCtbInTile = TileId[ CtbAddrInTs ] = =
TileId[ CtbAddrRsToTs[ CtbAddrInRs − PicWidthInCtbsY ] ]
if( upCtbInSliceSeg && upCtbInTile && saoInUp )

| | |
|---|---|
| merge_up | ae(v) |

}
if( !merge_up && !merge_left )

for( cIdx = 0; cIdx < 3; cIdx++ )

if( ( slice_sao_luma_flag && cIdx = = 0 ) | |
( slice_sao_chroma_flag && cIdx > 0 ) ) {

if( cIdx = = 0 )

| | |
|---|---|
| sao_type_idx_luma | ae(v) |

else if( cIdx = = 1 )

| | |
|---|---|
| sao_type_idx_chroma | ae(v) |

if( SaoTypeIdx[ cIdx ][ rx ][ ry ] != 0 ) {

for( i = 0; i < 4; i++ )

| | |
|---|---|
| sao_offset_abs[ cIdx ][ rx ][ ry ][ i ] | ae(v) |

if( SaoTypeIdx[ cIdx ][ rx ][ ry ] = = 1 ) {

for( i = 0; i < 4; i++ )

if(sao_offset_abs[ cIdx ][ rx ][ ry ][ i ] != 0 )

| | |
|---|---|
| sao_offset_sign[ cIdx ][ rx ][ ry ][ i ] | ae(v) |
| sao_band_position[ cIdx ][ rx ][ ry ] | ae(v) |

} else {

if( cIdx = = 0 )

| | |
|---|---|
| sao_eo_class_luma | ae(v) |

if( cIdx = = 1 )

| | |
|---|---|
| sao_eo_class_chroma | ae(v) |

}

}

}

}

The parameters saoInLeft and saoInUp may specify whether SAO syntax exists in the left and above LCUs respectively. For example, saoInLeft=1 may indicate that SAO syntax is present for the left LCU, while saoInLeft=0 may indicate that there is no SAO syntax for the left LCU. Similarly, saoInUp=1 may indicate that SAO syntax is present for the above LCU, while saoInUp=0 may indicate that there is no SAO syntax for the above LCU. saoInLeft and saoInUp may be implicitly derived as follows:
saoInLeft=(rx>0)&&(SaoTypeIdx[0][rx-1][ry]!=0∥SaoTypeIdx[1][rx-1][ry]!=0∥SaoTypeIdx[2][rx-1][ry]!=0)
saoInUp=(ry>0)&&(SaoTypeIdx[0][rx][ry-1]!=0∥SaoTypeIdx[1][rx][ry-1]!=0∥SaoTypeIdx[2][rx][ry-1]!=0)
   Other data elements may appear as defined by ITU-T H.265, e.g., SaoTypeIdx may be an array specifying an offset type for a LCU at location (rx, ry).

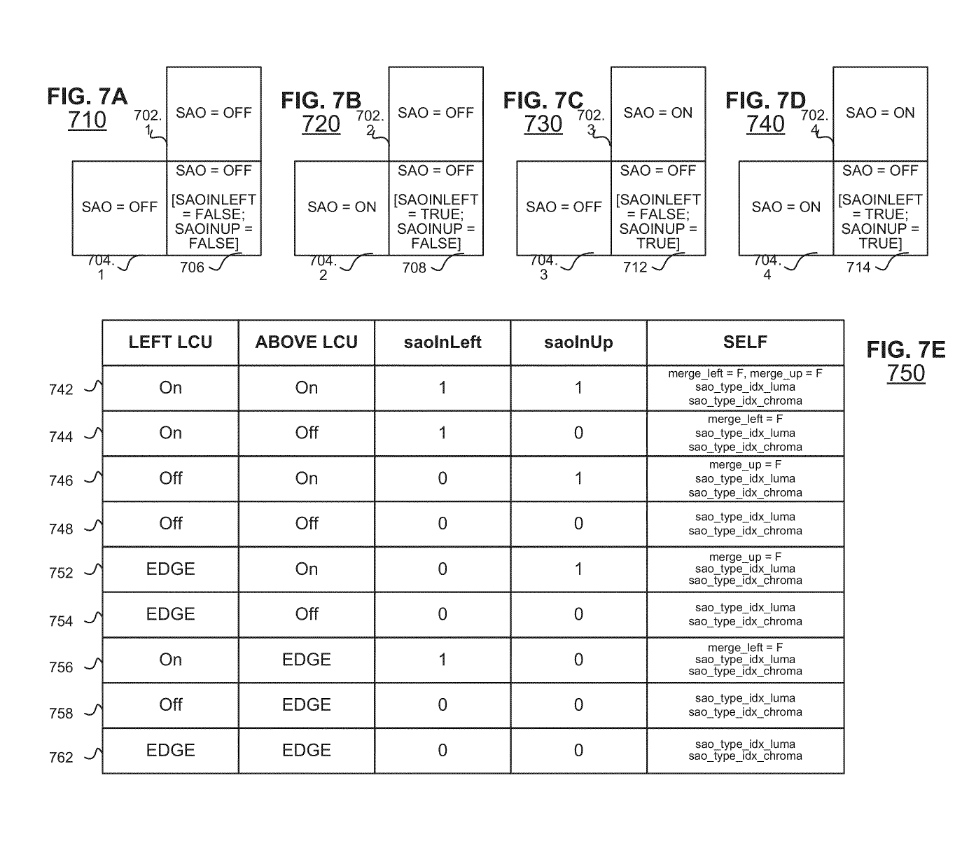

FIGS. 7A-7D illustrate various neighboring LCU configurations 710-740 in a method of signaling that SAO is off for a LCU. In configuration 710, for a current LCU 706, both a left neighbor 704.1 and an above neighbor 702.1 do not use SAO. In this situation, to signal that the current LCU does not use SAO, saoInLeft and saoInUp may both be FALSE. In configuration 720, for a current LCU 708, a left neighbor 704.2 uses SAO and an above neighbor 702.2 does not use SAO. In this situation, to signal that the current LCU does not use SAO, saoInLeft may be TRUE and saoInUp may be FALSE. In configuration 730, for a current LCU 712, a left neighbor 704.3 does not use SAO and an above neighbor 702.3 uses SAO. In this situation, to signal that the current LCU does not use SAO, saoInLeft may be FALSE and saoInUp may be TRUE. In configuration 240, for a current LCU 714, both a left neighbor 704.4 and an above neighbor 702.4 use SAO. In this situation, to signal that the current LCU does not use SAO, saoInLeft and saoInUp may both be TRUE.

FIG. 7E is a table 750 summarizing each configuration of neighboring blocks 710-740 and corresponding syntax elements. For example, row 748 may correspond to configuration 710. As illustrated, sao_type_idx_luma and/or sao_type_idx_chroma may be directly signaled without signaling merge_left and merge_up. That is, compared with typical SAO signaling, resources to signal two flags may be saved, because two instead of four syntax elements may be used. As another example, row 744 may correspond to configuration 720. As illustrated, the merge_up may be skipped, and merge_left=FALSE and sao_type_idx_luma and/or sao_type_idx_chroma may be signaled. That is, compared with typical SAO signaling, three instead of four syntax elements may be used. As a further example, row 746 may correspond to configuration 730. As illustrated, the merge_left may be skipped, and merge_up=FALSE and sao_type_idx_luma and/or sao_type_idx_chroma may be signaled. That is, compared with typical SAO signaling, three instead of four syntax elements may be used. As yet another example, row 742 may correspond to configuration 740. As illustrated, merge_up, merge_up, and sao_type_idx_luma and/or sao_type_idx_chroma may be signaled.

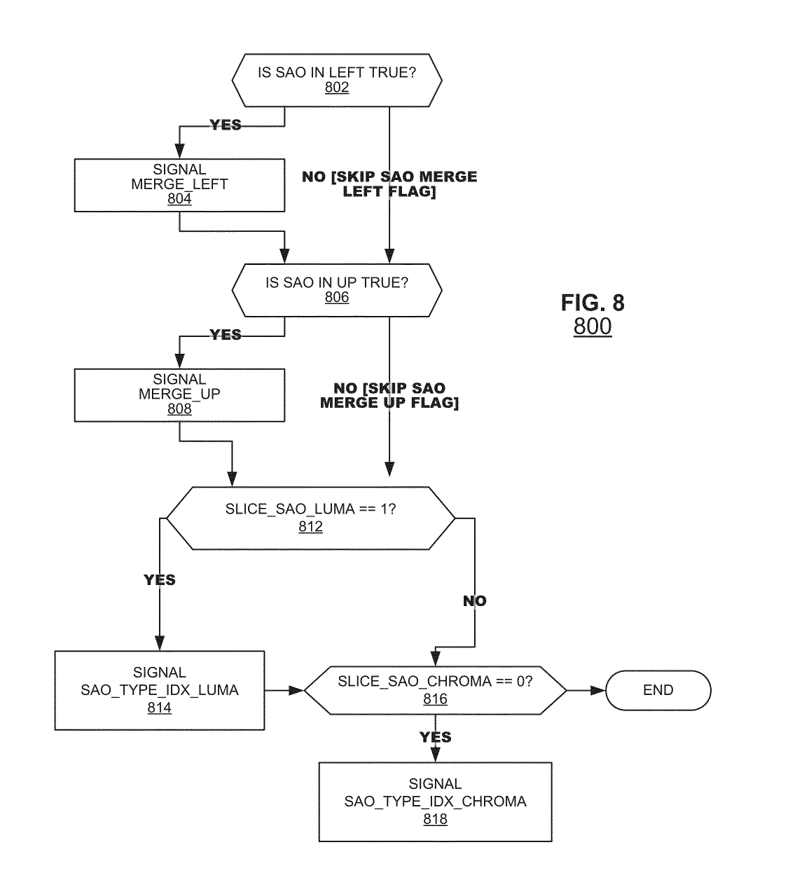

FIG. 8 illustrates yet another method 800 of signaling SAO status when SAO of a current LCU is set to off according to an embodiment of the present disclosure. In this embodiment, the method 800 may use additional parameters saoInLeft and saoInUp to make its determinations, where saoInLeft and saoInUp may be implicitly derived and not signaled in the bitstream.

In box 802, the method 800 may determine whether SAO is performed for an LCU to the left of the LCU being coded, e.g., saoInLeft may be true if SAO is performed for the left LCU. If saoInLeft is true, then the method 800 may signal merge_left in box 804. For example, rows 742, 744, 756 of the table 750 may correspond to this branch. Otherwise, if saoInLeft is not true, the method 800 may skip the merge_left and proceed directly to box 806. For example, rows 746-754, 758, and 762 of the table 750 may correspond to this branch. This may save signaling resources by saving the bits associated with signaling the merge_left. In box 806, the method 800 determines whether SAO is performed for an LCU above the LCU being coded, e.g., saoInUp may be true if SAO is performed for the above LCU. If saoInUp is true, the method 800 may signal merge_up in box 808. For example, rows 742, 746, 752 of the table 750 may correspond to this branch. Otherwise, if saoInUp is not true, the method 800 may skip the merge_up and proceed directly to box 812. For example, rows 744, 748, 754-762 of the table 750 may correspond to this branch.

To determine whether either or both sao_type_idx_luma and sao_type_idx_chroma are signaled, the method 800 may determine in box 812 whether SAO is enabled for a luma component and the method 800 may determine in box 816 whether SAO is enabled for a chroma component. For example, according to subclause 7.4.7.1 of the HEVC standard, slice_sao_luma_flag equals 1 specifies that SAO is enabled for the luma component in the current slice; slice_sao_luma_flag equals 0 specifies that SAO is disabled for the luma component in the current slice; and when slice_sao_luma_flag is not present, it is inferred to be 0. Likewise, slice_sao_chrom_flag equals 1 specifies that SAO is enabled for the chroma component in the current slice; slice_sao_chroma_flag equals 0 specifies that SAO is disabled for the chroma component in the current slice; and when slice_sao_chroma_flag is not present, it is inferred to be 0.

If it is determined in box 812 that the luma component is enabled for the current slice, e.g., slice_sao_luma==1, the method 800 may signal sao_type_idx_luma in box 814 and proceed to box 816. If it is determined in box 812 that the luma component is not enabled, the method 800 may proceed to box 816 without signaling sao_type_idx_luma. In box 816 the method 800 may evaluate whether SAO is enabled for the chroma component, e.g., slice_sao_chroma==0. If the chroma component uses SAO, then the method 800 may proceed to step 818 in which it signals sao_type_idx_chroma. If the chroma component does not use SAO, the method 800 may terminate without signaling sao_type_idx_chroma.

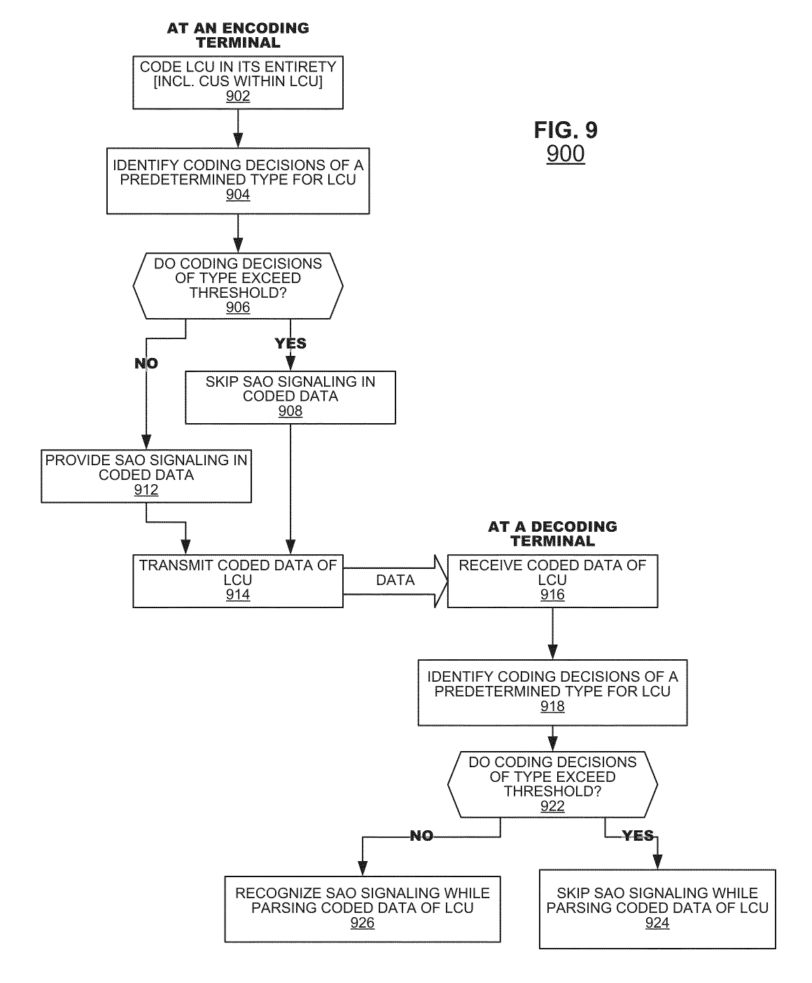

FIG. 9 illustrates a method 900 of signaling SAO status according to an embodiment of the present disclosure, when SAO of a current LCU is set to off The method 900 may perform boxes 902 to 914 at an encoding terminal. In box 902, the method 900 may code an LCU in its entirety, including coding units (CUs) within the LCU. The method 900 may then identify coding decisions of a predetermined type for the coded LCU (box 904). If the coding decisions of the predetermined type exceed a threshold in box 906, then the method may proceed to box 908 in which SAO signaling is skipped for the coded data. If, on the other hand, the coding decisions of the predetermined type do not exceed a threshold, the method 900 may provide SAO signaling in the coded data (box 912) according to typical methods and the methods further described herein. In box 914, the method 900 may transmit the coded data of the LCU.

The method 900 may perform boxes 916 to 926 at a decoding terminal. In box 916, the method 900 may receive coded data of the LCU. The method 900 may then identify coding decisions of a predetermined type for the received LCU (box 918). If the method 900 determines in box 922 that the coding decision of the predetermined type exceeds a threshold, then the method 900 may skip SAO signaling while parsing the coded data of the LCU (box 924). Otherwise, the method 900 may recognize that SAO offsets are signaled in the bitstream and parse the coded data of the LCU accordingly (box 926).

According to this embodiment, an LCU's coding parameters may indicate whether SAO filtering is used for the entire LCU. The coding decisions considered by method 900 to determine whether SAO signaling is skipped may include: a number (including percentage or ratio) of coding units (“CUs”) within the LCU that are skipped, a number of coefficients or energy level of coefficients surviving entropy coding, a number of motion vectors for the CUs, and prediction modes for the CUs. For instance, a percentage of CUs within the LCU exceeding a threshold may indicate that a large number of CUs have been skipped and SAO signaling for the entire LCU may be skipped. An energy level of coefficients below a threshold may indicate that a reference frame has relatively few variations and SAO signaling may be skipped. A small number of motion vectors may also indicate that a particular portion of the bitstream may not benefit from SAO, and the entire LCU may skip SAO filtering. Whether SAO filtering is skipped for an entire LCU may be implicitly signaled, for example by using a flag at the sequence (SPS) or picture parameter set (PPS) level.

As used in the appended claims, the term “computer-readable medium” may include a single medium or multiple media, such as a centralized or distributed database, and/or associated caches and servers that store one or more sets of instructions. The term shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

The present specification describes components and functions that may be implemented in particular embodiments which may operate in accordance with one or more particular standards and protocols. However, the principles of the present disclosure may find application with other standards and protocols as they are defined.

Operation of the disclosed embodiments has been described in the context of terminals that implement video compression, coding, and decoding. These systems can be embodied in electronic devices or integrated circuits, such as application specific integrated circuits, field programmable gate arrays and/or digital signal processors. Alternatively, they can be embodied in computer programs that execute on personal computers, notebook computers, tablets, smartphones or computer servers. Such computer programs typically are stored in physical storage media such as electronic-, magnetic- and/or optically-based storage devices, where they may be read to a processor, under control of an operating system and executed. And, of course, these components may be provided as hybrid systems that distribute functionality across dedicated hardware components and programmed general-purpose processors, as desired.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure.

What is claimed is:

1. A method of signaling a state of sample adaptive offset (SAO) for a given coding unit, the method comprising:
determining whether the SAO state for the given coding unit is different from an SAO state of a first neighbor in a first scanning direction; and
if the SAO state for the given coding unit is different from the SAO state of the first neighbor:
determining whether the SAO state of the first neighbor is off; and
if the SAO state of the first neighbor is off, signaling the SAO state of the given coding unit with a single flag.

2. The method of claim 1, wherein the single flag is a merge flag that indicates that the SAO state of the given coding unit is derived from the first neighbor.

3. The method of claim 1, further comprising, if the SAO state for the given coding unit is different from the SAO state of the first neighbor:
when the SAO state of the first neighbor is not off, determining whether an SAO state is off for a second neighbor in a second scanning direction; and
if the SAO state of the second neighbor is off and the SAO state of the first neighbor is on, signaling the SAO state for the given coding unit with two flags.

4. The method of claim 3, wherein the two flags include a first merge flag that indicates that the SAO state of the given coding unit is derived from the first neighbor and a second merge flag that indicates that the SAO state of the given coding unit is derived from the second neighbor.

5. The method of claim 1, further comprising:
when the SAO state of the first neighbor is not off, determining whether an SAO state is off for a second neighbor in a second scanning direction; and
if the SAO state of the first neighbor is on and the SAO state of the second neighbor is on, signaling the SAO state for the given coding unit with a first and a second merge flag and a flag for each color component of the given coding unit.

6. The method of claim 1, further comprising:
if the given coding unit does not have a neighbor in one of a first scan direction or a second scan direction and an SAO state of a neighbor in the other of the first or second scan direction is off, signaling the SAO state of the given coding unit with a single flag.

7. The method of claim 1, further comprising:
if the given coding unit does not have a neighbor in one of the first scanning direction or a second scanning direction and an SAO state of a neighbor in the other of the first or second scanning direction is on, signaling the SAO state of the given coding unit with a merge flag and a flag for each color component of the given coding unit.

8. The method of claim 1, further comprising:
if the given coding unit does not have a neighbor in a first scan direction and does not have a neighbor in a second scan direction, signaling the SAO state of the given coding unit with a flag for each color component of the given coding unit.

9. The method of claim 1, further comprising:
identifying coding decisions of predetermined type for a plurality of coding units; and
if the coding decisions of a predetermined type exceeds a predetermined threshold, skipping SAO signaling for the plurality of coding units.

10. The method of claim 1, wherein the method is performed at an encoder and said signaling is received in a bitstream with coded data corresponding to the coding unit at a decoder.

11. A method of signaling a state of sample adaptive offset (SAO) for coding units of a frame, the method comprising:
iteratively, for a plurality of coding units within a frame:
determining whether the respective coding unit has a first neighbor in a first scanning direction, and
when the respective coding unit does not have a first neighbor, coding an SAO state of the respective coding unit according to an SAO state of a coding unit in a second scanning direction in relation to the respective coding unit, and
otherwise, coding the SAO state of the respective coding unit according to an SAO state of the coding unit in a first direction in relation to the respective coding unit;
wherein a protocol for representing SAO state of the coding units at an interior of the frame includes a field for a flag representing state of neighbors in the first scanning direction of the interior coding units but the protocol does not include such a flag for: (a) coding units at an edge with respect to the first scanning direction of the frame and (b) coding units that do not have a first neighbor.

12. The method of claim 11, further comprising:
when the respective coding unit does not have a first neighbor and does not have a second neighbor, signaling the state of SAO for the respective coding unit with a flag for each color component of the respective coding unit.

13. The method of claim 11, wherein the flag representing state of neighbors indicates that the SAO state of the respective coding unit is derived from a neighbor in the first scanning direction.

14. The method of claim 11, further comprising:
if the first neighbor's SAO state is on, signaling the SAO state of the respective coding unit with a single flag.

15. The method of claim 11, further comprising:
if the SAO state of the second neighbor is off and the SAO state of the first neighbor is on, signaling the SAO state for the respective coding unit with a flag for each color component of the given coding unit.

16. The method of claim 11, a state of SAO is signaled at a slice level such that one slice is used for coding units with SAO in a first state and another slice is used for coding units with SAO in another state.

17. A signaling method for sample adaptive offset (SAO) data, comprising:
signaling SAO data for each of a plurality of coding units in a frame according to a variable field signaling protocol;
wherein, for each coding unit in an interior of the frame:
when SAO signaling is present for a first previously-coded coding unit adjacent to a present coding unit in a first direction and an SAO state of the first previously-coded coding unit agrees with an SAO state of the present coding unit, the signaling comprises providing a flag indicating that the SAO state of the present coding unit is the same as the SAO state of the first previously-coded coding unit;
otherwise, when SAO signaling is present for a second previously-coded coding unit adjacent to the present coding unit in a second direction and an SAO state of the second previously-coded coding unit agrees with the SAO state of the present coding unit, the signaling comprises providing a pair of flags, a first flag indicating that the SAO state of the present coding unit does not agree with the SAO state of the first previously-coded coding unit and a second flag indicating that the SAO state of the present coding unit is the same as the SAO state of the second previously-coded coding unit;
otherwise, the signaling providing SAO state data in a four field syntax unit including a pair of flags indicating that the SAO state of the present coding unit does not agree with the SAO state of the first previously-coded coding unit and the SAO state of the second previously-coded coding unit, the syntax unit also including a pair of fields with SAO state values.

18. The method of claim 17 wherein, for each coding unit on an edge of the frame in the first scanning direction:
when SAO signaling is present for a previously-coded coding unit adjacent to the edge coding unit in the second direction and an SAO state of adjacent previously-coded coding unit agrees with the SAO state of the edge coding unit, the signaling comprises providing a flag indicating that the SAO state of the present coding unit is the same as the SAO state of the adjacent previously-coded coding unit;
otherwise, the signaling providing SAO state data in a three field syntax unit including a flags indicating that the SAO state of the edge coding unit does not agree with the SAO state of the adjacent previously-coded coding unit, the syntax unit also including a pair of fields with SAO state values.

19. The method of claim 17 wherein, for each coding unit on an edge of the frame in the second scanning direction:
when SAO signaling is present for a previously-coded coding unit adjacent to the edge coding unit in the first direction and an SAO state of adjacent previously-coded coding unit agrees with the SAO state of the edge coding unit, the signaling comprises providing a flag indicating that the SAO state of the present coding unit is the same as the SAO state of the adjacent previously-coded coding unit;
otherwise, the signaling providing SAO state data in a three field syntax unit including a flags indicating that the SAO state of the edge coding unit does not agree with the SAO state of the adjacent previously-coded coding unit, the syntax unit also including a pair of fields with SAO state values.

20. A method of multifield signaling a state of sample adaptive offset (SAO) for coding units of a frame, the method comprising:
iteratively, for a plurality of coding units within a frame:
determining whether SAO syntax is present in a neighbor coding unit in a first scanning direction in relation to a respective coding unit;
determining whether SAO syntax is present in a neighbor coding unit in a second scanning direction in relation to the respective coding unit; and
if SAO syntax is present in both the first scanning direction and the second scanning direction, signaling SAO for each color component.

21. The method of claim 20, further comprising:
if SAO syntax is present in only one of the first and second scanning directions, using a field to signal SAO for each color component and a field to signal that the SAO state of the given coding unit is derived from a neighbor.

22. The method of claim 20, further comprising:
if SAO syntax is not present in the first and second scanning directions, using a field to signal SAO for each color component of the respective coding unit.

23. The method of claim 20, wherein a protocol for representing SAO state of the coding units at an interior of the frame includes a field for a flag representing an SAO state of neighbors in the first scanning direction of the interior coding units.

24. The method of claim 20, wherein a protocol for representing SAO state of the coding units at an interior of the frame includes a field for a flag representing a color component for a slice.

25. A video coding system comprising:
a coder configured to:
determine whether the SAO state for the given coding unit is different from an SAO state of a first neighbor in a first scanning direction; and
if the SAO state for the given coding unit is different from the SAO state of the first neighbor:
determine whether an SAO state is off for the first neighbor; and
if the first neighbor's SAO state is off, signal the SAO state of the given coding unit with a single flag.

26. A non-transitory computer-readable medium storing program instructions that, when executed, cause a processor to perform a method, the method comprising:
determining whether the SAO state for the given coding unit is different from an SAO state of a first neighbor in a first scanning direction; and
if the SAO state for the given coding unit is different from the SAO state of the first neighbor:
determining whether an SAO state is off for the first neighbor; and
if the first neighbor's SAO state is off, signaling the SAO state of the given coding unit with a single flag.

27. An SAO coding protocol with variable fields for representing an SAO state of a coding unit, the method comprising:
if the SAO state of the coding unit matches an SAO state of a first neighbor in a first scanning direction, including a sole field for representing the SAO state of the coding unit;
if the SAO state of the coding unit is different from the SAO state of the first neighbor but matches an SAO state of a second neighbor in a second scanning direction, including two fields for representing the SAO state of the coding unit; and
if the coding unit does not have a first neighbor in a first scanning direction and the SAO state of the coding unit matches an SAO state of any neighbor, including a sole field for representing the SAO state of the coding unit.

28. A decoding method comprising:
upon encountering a first flag, performing SAO filtering for a given coding unit according to SAO filtering performed by a neighbor coding unit in a first scanning direction;
upon encountering a second flag, performing SAO filtering for a given coding unit according to SAO filtering performed by a neighbor coding unit in a second scanning direction;
upon encountering a third flag signaling an SAO state of the neighbor coding unit in the first direction, performing SAO filtering for a given coding unit according to the SAO filtering performed by the neighbor coding unit in the first scanning direction; and
upon encountering a fourth flag signaling an SAO state of the neighbor coding unit in the first direction, performing SAO filtering for a given coding unit according to the SAO filtering performed by the neighbor coding unit in the second scanning direction.
